(19) United States
(12) Patent Application Publication
(10) Pub. No.: US 2006/0155592 A1
(43) Pub. Date: Jul. 13, 2006

(54) Method for taking stock and/or monitoring the inventory of stored object and /or merchandise, resource planning system, computer program for a resource planning system, and computer program for a sensor device

(76) Inventors: Wolf-Dieter Burkert, Rosenheim (DE); Alfred Koch, Kemnath (DE); Gerhard Sammer, Ergoldsbach (DE); Rolf Schuster, Augsburg (DE); Krishna Shah, Grafeling (DE)

Correspondence Address: STAAS & HALSEY LLP, SUITE 700, 1201 NEW YORK AVENUE, N.W., WASHINGTON, DC, 20005, US

(21) Appl. No.: 10/545,015

(22) PCT Filed: Jan. 13, 2004
(86) PCT No.: PCT/EP04/00170

§ 371 Date: Feb. 13, 2006

(30) Foreign Application Priority Data
Feb. 10, 2003 (EP) 03002931.8

(51) Int. Cl. G06F 17/50

(52) U.S. Cl. 705/7

(57) ABSTRACT

To take stock or monitor the inventory of stored objects or merchandise, a storage place or an optically scannable identifier, by which the object or the piece of merchandise can be identified, are assigned to a stored object or piece of merchandise. An electronic image is recorded at a given moment in time to determine whether the storage place is occupied or scan the identifier. A signal characterizing the recorded electronic image is transmitted to an evaluation unit via a mobile communication interface. A stock indicator that is assigned to the storage place or the identifier is adjusted by the evaluation unit based on the transmitted signal.

### CROSS REFERENCE TO RELATED APPLICATIONS

This application is based on and hereby claims priority to European Application No. 03002931 filed on Feb. 10, 2003, the contents of which are hereby incorporated by reference.

### BACKGROUND OF THE INVENTION

Document U.S. Pat. No. 5,278,750 discloses a method for creating a production plan for a selected production process from which emerges a plurality of products which are transferred to a downstream processing or handling process. In carrying out the method a flowchart for the downstream processing or handling process is first drawn up, and includes information about required products and, delivery times. A flowchart is also drawn up for a transport process from the selected production process to the downstream processing or handling process. Products forwarded to the transport process are provided with an accompanying ticket, from here on known as KANBAN, containing delivery information. A product dispatch plan is created on the basis of the flowcharts for the downstream processing or handling process and the transport process, together with the KANBAN. In addition, the terms and conditions for work and production are drawn up for the selected production process. A production plan is created for the selected production process on the basis of the product dispatch plan and the terms and conditions for work and production. Finally production orders for the products that need to be manufactured are created on the basis of the production plan for the selected production process.

Document DE 100 41 398 A1 discloses a method for determining the requirement for components at a workplace, in which the quantity of inventory storage bins per component type at a workplace is electronically scanned by sensors. As soon as the number of storage bins at a workplace declines, a computer generates a demand signal. The demand signal increases the counter status of a component-specific demand counter, whereupon a quantity of storage bins corresponding to the counter status is transported to the workplace.

The potential benefits offered by KANBAN-based production planning and control methods include minimized outlay on central control, shortened process throughput times and lower inventory levels. In particular the accurate and rapid determination of inventory levels is highly significant for efficient procedural flow.

### SUMMARY OF THE INVENTION

An object of the present invention is personnel-free inventory management of stored objects and/or merchandise.

An important aspect of the present invention is that a storage location and/or optically scannable identifier, by which the object and/or piece of merchandise can be identified, are assigned to a stored object and/or piece of merchandise. An electronic image is recorded at a given moment in time in order to determine whether the storage location is occupied and/or to scan the identifier. A signal characterizing the recorded electronic image is transmitted to an evaluation unit. On the basis of this transmitted signal, the evaluation unit adjusts an inventory level indicator assigned to the storage location and/or identifier. An inventory level for the respective objects and/or merchandise can be derived from this inventory level indicator without the need for manual intervention by personnel from operational management or inventory management.

The demands imposed by electronic image recording are considered to be slight in the present invention, since for example light and shade differentiation has already been adequately developed.

### BRIEF DESCRIPTION OF THE DRAWINGS

These and other objects and advantages of the present invention will become more apparent and more readily appreciated from the following description of a typical embodiment, taken in conjunction with the accompanying drawings of which:

FIG. 1 is a flowchart of a method for inventory monitoring and/or recording,

FIG. 2 is a diagram of an environment for an application to which the present invention relates.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

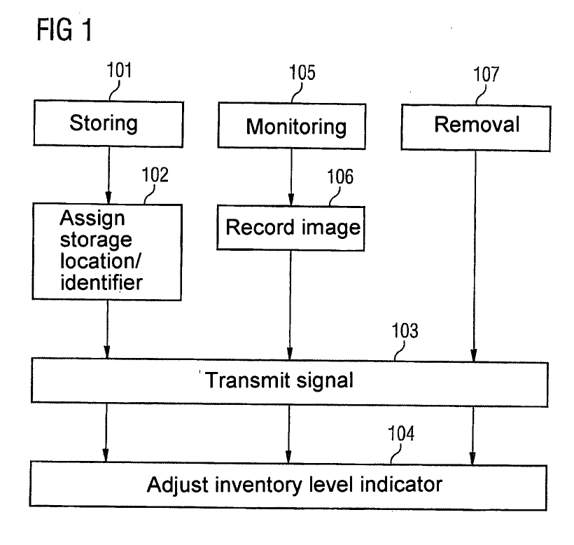

As FIG. 1 shows, the starting point for the flowchart of a method for inventory monitoring and/or recording is the storage, at the inventory storage location, of an object or piece of merchandise that has to be stored (step 101). Next the stored object or piece of merchandise is assigned to the storage location or to an optically scannable identifier at the object or piece of merchandise (step 102). A signal characterizing this procedure is transmitted to an evaluation unit via a mobile communication interface (step 103). Finally an inventory level indicator that is assigned to the storage location and/or identifier is adjusted by the evaluation unit, based on the transmitted signal (step 104). An inventory level for the respective objects and/or merchandise can be derived from this indicator.

When monitoring an inventory of stored objects or pieces of merchandise (step 105), an electronic image is recorded at a given moment in time in order to determine whether the storage location is occupied and/or to scan the identifier at the respective object or piece of merchandise (step 106). A signal characterizing the recorded electronic image is then transmitted to an evaluation unit via a mobile communication interface (step 103). Finally, as with the method when storing an object or piece of merchandise that has to be stored, an inventory level indicator that is assigned to the storage location and/or identifier is adjusted by the evaluation unit, based on the transmitted signal (step 104).

On the removal of a stored object or piece of merchandise (step 107) a signal characterizing this procedure is transmitted to the evaluation unit via a mobile communication interface (step 103). Finally the inventory level indicator is likewise adjusted by the evaluation unit, based on the transmitted signal (step 104).

in particular an inventory level can be determined on the basis of information about a storage location, the number of storage devices at the storage location and the number of objects per storage device. This applies for example in the case of piece goods. In the case of goods in bulk, an inventory level can be determined for example on the basis of information about a storage location, the number of storage devices at the storage location and the height of fill of a storage device. To determine the height of fill of an at least partially transparent storage device, the light and dark boundary between the full and empty sub-ranges of the at least partially transparent storage device is recorded by an electronic camera.

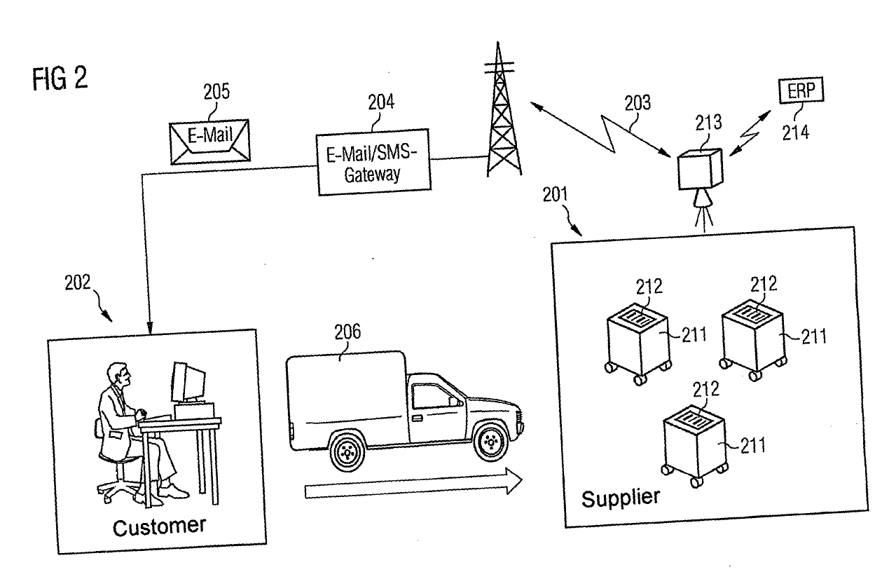

In the diagram shown in FIG. 2 of an environment for an application for the present invention, a storage facility, such as warehouse 201, belonging to a customer, for storing objects and/or merchandise, contains a plurality of storage devices 211 for objects or merchandise that have to be stored. These storage devices 211 are provided with an optically scannable identifier 212, such as a barcode, a transport ticket or a storage ticket. A transport ticket or storage ticket can be recorded and evaluated by optical character recognition (OCR).

The identifiers 212 provided on the storage devices 211 are recorded by a computer-based sensor device 213 having an integrated electronic camera and an integrated mobile communication device. In a random access memory of the computer-based sensor device 213 it is possible to load a computer program having at least one code section, so that when this code is executed an electronic image is recorded at a given moment in time in order to determine whether a storage location is occupied and/or to scan an identifier, and a signal characterizing the electronic image is transmitted to an evaluation unit 202 via a mobile communication interface 203. In the present case the evaluation unit 202 is assigned to a supplier.

The computer-based sensor device 213 is under the control of a resource planning system 214 which has a processor unit and a random access memory (not shown in close detail in FIG. 2). In addition the resource planning system 214 causes a stored object or piece of merchandise to be assigned to a storage location or optically scannable identifier 212, an electronic image to be recorded by the camera of the computer-based sensor device 213, a signal characterizing the recorded electronic image to be transmitted to the evaluation unit 202, and an inventory level indicator assigned to the storage location or identifier 212 to be adjusted by the evaluation unit 202. To ensure that these steps are executed, a computer program is installed in the resource planning system 214, the program being loadable into the random access memory of the resource planning system and having at least one code section, so that when this code is executed the storage location or optically scannable identifier is assigned, the electronic image is recorded, the signal characterizing the recorded electronic image is transmitted and the inventory level indicator is adjusted, when the computer program in the resource planning system is running.

The signal characterizing the image recorded by the electronic camera of the computer-based sensor device 213 is first transmitted as a short message (SMS) via the mobile communication interface 203 and then, in an e-mail/SMS gateway 204, converted into an e-mail message 205 which is transmitted to the supplier-side evaluation unit 202. Based on the current supplier-side availability of an object or piece of merchandise or based on customer-side usage, the customer is provided with demand-led replenishment of the needed objects or merchandise. This demand-led replenishment is carried out by transport 206, for instance by road, rail or air. For the purpose of providing the customer with demand-led replenishment of required objects or merchandise, the customer side and supplier side are connected in a KANBAN feedback loop.

In the application environment shown in FIG. 2, the computer-based sensor device 213 has the task of recording, determining and checking the plausibility of event-led inventory levels, times and changes, having regard to quantities against bandwidths, delivery times against bandwidths, usage rate and storage location. For this purpose the computer-based sensor device 213 reports appropriate events to supplier-side and customer-side department heads and/or logistics specialists. This also includes supplier-side and customer-side resource planning systems, also known as enterprise resource planning systems (ERP).

The application of the present invention is not confined to the typical embodiment described here.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. A method for at least one of taking stock and monitoring the inventory of at least one of stored objects and merchandise, comprising:
assigning at least one of a storage location and an optically scannable identifier to at least one of a stored object and a piece of merchandise, for identifying the at least one of the object and the piece of merchandise;
recording an electronic image at a given moment in time to at least one of obtain a scan of the optically scannable identifier and determine whether the storage location is occupied;
transmitting a first signal characterizing the electronic image to an evaluation unit via a mobile communication interface; and
adjusting an inventory level indicator assigned to the at least one of the storage location and the optically scannable identifier by the evaluation unit based on the first signal.

12. A method according to claim 11, further comprising:
transmitting, to the evaluation unit via the mobile communication interface, a second signal upon removal of the at least one of the stored object and the piece of merchandise; and
further adjusting the inventory level indicator by the evaluation unit based on the second signal.

13. A method according to claim 12, further comprising when at least one of another object and another piece of merchandise is stored at the storage location:
assigning the at least one of the storage location and the optically scannable identifier to the at least one of the other object and the other piece of merchandise;
transmitting, to the evaluation unit via the mobile communication interface, a third signal indicating storage of the at least one of the other object and the other piece of merchandise; and
further adjusting the inventory level indicator by the evaluation unit based on the third signal.

14. A method according to claim 13, further comprising determining an inventory level based on information about a storage facility, a number of storage devices at the storage facility and a number of objects per storage device.

15. A method according to claim 13, further comprising determining an inventory level based on information about a storage facility, a number of storage devices at the storage facility and a height of fill of a storage device.

16. A method according to claim 15, further comprising recording a light and dark boundary between full and empty sub-ranges of an at least partially transparent storage device by an electronic camera to determine the height of fill of the at least partially transparent storage device.

17. A method according to claim 16, wherein the storage facility is assigned to a customer and the evaluation unit is assigned to a supplier within a KANBAN feedback loop.

18. A resource planning system coupled to an evaluation unit via a mobile communication interface, comprising:
a processor unit;
a random access memory;
means for assigning at least one of a stored object and a piece of merchandise to at least one of a storage location and an optically scannable identifier, for identifying the at least one of the object and the piece of merchandise;
means for causing an electronic image to be recorded at a given moment in time to at least one of obtain a scan of the optically scannable identifier and determine whether the storage location is occupied;
means for causing a signal characterizing the electronic image to be transmitted to the evaluation unit via the mobile communication interface; and
means for causing an inventory level indicator assigned to the at least one of the storage location and the optically scannable identifier to be adjusted by the evaluation unit based on the signal.

19. At least one computer readable medium storing a computer program loadable into a random access memory of a computer-based resource planning system that when executed controls the computer-based resource planning system to perform a method comprising:
assigning at least one of a storage location and an optically scannable identifier to at least one of a stored object and a piece of merchandise, for identifying the at least one of the object and the piece of merchandise;
recording an electronic image at a given moment in time to at least one of obtain a scan of the optically scannable identifier and determine whether the storage location is occupied;
transmitting a first signal characterizing the electronic image to an evaluation unit via a mobile communication interface; and
adjusting an inventory level indicator assigned to the at least one of the storage location and the optically scannable identifier by the evaluation unit based on the first signal.

20. A computer program loadable into a random access memory of a computer-based sensor device that when executed controls the computer-based sensor device to perform a method comprising:
recording an electronic image at a given moment in time to at least one of determine whether a storage location is occupied and scan an identifier for at least one of an object and a piece of merchandise; and
transmitting a signal characterizing the recorded electronic image to an evaluation unit via a mobile communication interface.
